(19) United States
(12) Patent Application Publication
(10) Pub. No.: US 2025/0228397 A1
(43) Pub. Date: Jul. 17, 2025

(54) MICROWAVE BAKING TRAY WITH RIGID SUPPORTS

(71) Applicant: Huamin PENG, Foshan (CN)

(72) Inventors: Huamin PENG, Foshan (CN); Shuzheng TANG, Foshan (CN)

(21) Appl. No.: 19/169,980

(22) Filed: Apr. 3, 2025

Related U.S. Application Data
(63) Continuation of application No. PCT/CN2024/103296, filed on Jul. 3, 2024.

(30) Foreign Application Priority Data
Jun. 28, 2024 (CN) 202421521370.5

(51) Int. Cl. A47J 36/02

(52) U.S. Cl. CPC A47J 36/027

(57) ABSTRACT

A microwave baking tray with rigid supports, including a pair of supports and a microwave baking tray. The supports are installed on the outer sides of upper and lower units of the microwave baking tray, a lock catch is arranged on the supports, the lock catch is used to align position and snap with the upper and lower units, the upper and lower units of the microwave baking tray both include metal baking trays and baking tray sheaths, the supports include an upper horizontal bar and a lower horizontal bar, the upper and lower horizontal bars are connected by a connecting bar to form a frame structure, and the rigidity of the supports is greater than that of the baking tray sheath. The support connects the upper and lower units of the microwave baking tray to form a baking cavity, providing support and protection for the baking tray sheath.

### CROSS-REFERENCE

This application is a continuation of International Application No. PCT/CN2024/103296 with a filling date of Jul. 3, 2024, designating the United States, now pending, and further claims to the benefit of priority from Chinese Application No. 202421521370.5 with a filing date of Jun. 28, 2024. The content of the aforementioned applications, including any intervening amendments thereto, are incorporated herein by reference.

### TECHNICAL FIELD

This disclosure relates to the technical field of microwave oven appliances, in particular to a microwave baking tray with rigid supports.

### BACKGROUND

Microwave baking tray uses the microwave absorption layer on the surface of the baking tray to absorb microwaves to heat the tray body, and the food is baked or fried from the outside, changing the traditional way of microwave oven that generates heat inside the food and expanding the range of use of the microwave oven. In order to avoid the occurrence of sparking when metal baking trays come into contact with each other during microwave use, a baking tray sheath made of insulating elastic material is generally used to wrap the baking tray, such as a silicone sheath. However, the silicone sheath material is relatively soft and prone to misalignment during operation. On the other hand, the steam generated during cooking can cause the baking tray sheath to deform and bulge.

### SUMMARY

The objective of the present disclosure is to provide a microwave baking tray with rigid supports to overcome the shortcomings of the existing technology.

The technical solution of this disclosure is: a microwave baking tray with rigid supports, including a pair of supports and a microwave baking tray, wherein the supports are installed on the outer sides of the upper unit and the lower unit of the microwave baking tray, a lock catch is arranged on the supports, the lock catch is used to align position and snap with the upper unit and the lower unit, the upper unit and the lower unit of the microwave baking tray both include metal baking trays and baking tray sheaths, the supports include an upper horizontal bar and a lower horizontal bar, the upper horizontal bar is snapped with a top surface of the baking tray sheath, the lower horizontal bar is snapped with a side wall of a first sheath near a notch of the baking tray sheath, the upper horizontal bar and the lower horizontal bar are connected by a connecting bar to form a frame structure for the supports, and the rigidity of the supports is greater than that of the baking tray sheath.

The upper horizontal bar and the lower horizontal bar are not on the same plane, a plurality of buckles are distributed along frames of the supports, and the baking tray sheath is provided with installation grooves along the distribution of buckles.

The installation grooves are continuous and closed on a surface of the baking tray sheath, and the installation grooves are provided with buckle holes corresponding to each of the buckles.

The lower horizontal bar extends outward with a locking plate in a direction away from a center of the baking tray sheath, and the locking plate is provided with an U-shaped groove.

The microwave baking tray is provided with ventilation holes, the ventilation holes are located on a top surface of the baking tray sheath or a side wall of a second sheath of the baking tray sheath, or at a docking edge of the baking tray sheath.

Each of the supports consists of an upper support and a lower support, the upper support and the lower support are provided with the U-shaped groove, the lock catch includes a locking cover and a latch plate, the locking cover is hinged in the U-shaped groove of the upper support, and the latch plate is integrated on the bottom bend of the U-shaped groove of the lower support.

Hinge shafts are arranged on both sides of the U-shaped groove of the upper support, a hinge hole is arranged on the locking cover in an adaptive manner, and the hinge hole is provided with an guiding bell mouth.

The present disclosure has the following advantageous effects: the bending modulus of the support is greater than that of the baking tray sheath, so the rigidity of the support is greater than that of the baking tray sheath. The support not only docks and buckles the upper unit and the lower unit of the microwave baking tray through a lock catch, forming a baking cavity for food, but also supports and protects the baking tray sheath. Due to the rigidity of the support, the process of closing the baking tray and opening the baking cavity to take food out is very convenient, with an excellent user experience.

The upper horizontal bar is located on the top surface of the baking tray sheath, and the lower horizontal bar is close to the notch of the baking tray sheath, providing good support for the entire sheath.

### BRIEF DESCRIPTION OF THE DRAWINGS

FIG. 1 is a perspective view of the embodiment 1 of the present disclosure.

FIG. 2 is a transverse sectional view of the embodiment 1 of the present disclosure.

FIG. 3 is a longitudinal sectional view of the embodiment 1 of the present disclosure.

FIG. 4 is an exploded view of the embodiment 1 of the present disclosure.

FIG. 5 is a perspective view of the embodiment 2 of the present disclosure.

FIG. 6 is a sectional view of the embodiment 2 of the present disclosure.

### DETAILED DESCRIPTION OF THE EMBODIMENTS

The following will provide a clear and complete description of the technical solution of the present application in conjunction with the accompanying drawings. Based on the embodiments in the present application, all other embodiments obtained by ordinary skilled persons in the art without creative labor are within the scope of the present application.

### Embodiment 1

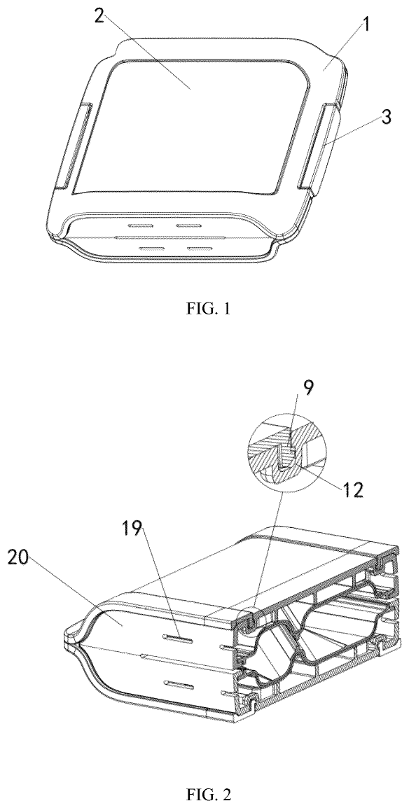

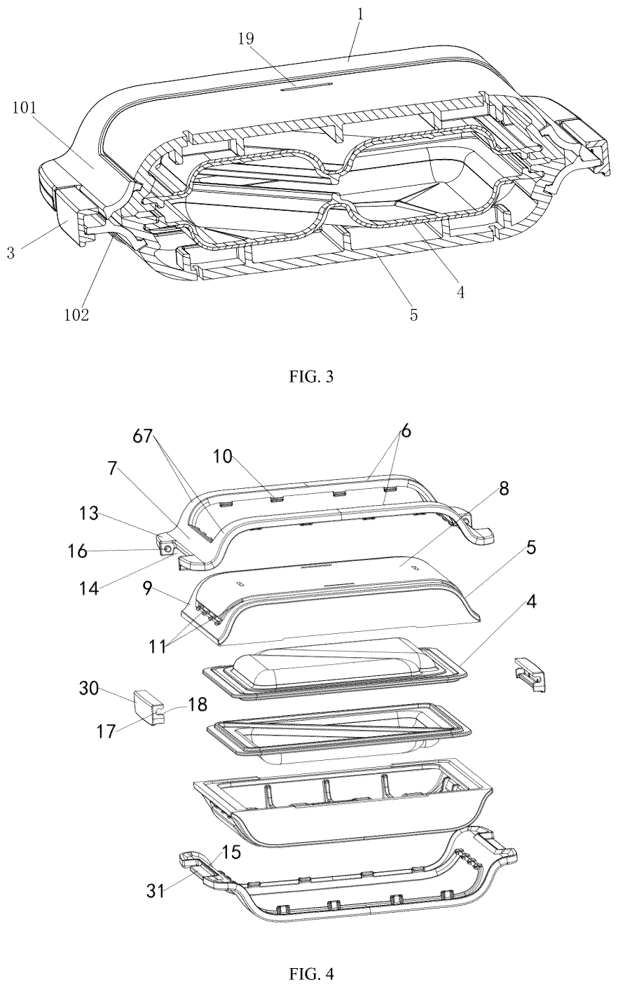

Referring to FIG. 1-4, a microwave baking tray with rigid supports includes a pair of supports 1 and a microwave baking tray 2. The supports are installed on the outer sides of the upper unit and the lower unit of the microwave baking tray, and a lock catch 3 is provided on the support to align position and snap with the upper unit and the lower unit. Each of the upper unit and the lower unit of the microwave baking tray includes a metal baking tray 4 and a baking tray sheath 5. The support includes an upper horizontal bar 6 and a lower horizontal bar 7. The upper horizontal bar is snapped with the top surface 8 of the baking tray sheath, and the lower horizontal bar is snapped with the side wall 9 of the first sheath near the notch of the baking tray sheath. The upper horizontal bar and the lower horizontal bar are not on the same plane. The upper horizontal bar and the lower horizontal bar are connected by a connecting bar 67 to form a frame structure for the support, and the rigidity of the support is higher than that of the baking tray sheath.

A plurality of buckles 10 are distributed along the frame of the support, and installation grooves 11 are arranged on the baking tray sheath along the distribution of buckles. The installation grooves 11 are continuous and closed on the surface of the baking tray sheath, which basically conforms to the shape of the inner edge of the frame of the support. The installation grooves are provided with buckle holes 12 corresponding to each buckle, so that the support is buckled and installed on the baking tray sheath.

The buckle holes 12 penetrate through the wall of the baking tray sheath, and the buckles 10 passed through the buckle holes 12. The supports are installed on the baking tray sheath. Alternatively, the buckle holes 12 extend horizontally inward at the bottom of the installation grooves 11, which can further allow the supports to be installed on the baking tray sheath, please refer to the enlarged partial view in FIG. 2.

The lower horizontal bar 7 extends outward with a locking plate 13 in the direction away from the center of the baking tray sheath, and the locking plate is provided with an U-shaped groove 14.

Each of the supports consists of an upper support 101 and a lower support 102. The upper support and the lower support are respectively provided with an U-shaped groove. The lock catch 3 includes a locking cover 30 and a latch plate 31. The locking cover is hinged in the U-shaped groove of the upper support, and the latch plate is integrated on the bottom bend 15 of the U-shaped groove of the lower support. Hinge shafts 16 are arranged on both sides of the U-shaped groove of the upper support, a hinge hole 17 is arranged on the lock cover, and the hinge hole is provided with an guiding bell mouth 18. Referring to FIG. 2 and FIG. 4, after the supports are snapped, the two horizontally arranged locking plates 13 are snapped with each other.

The metal baking trays of the upper unit and the lower unit of the microwave baking tray are provided with microwave absorption layers on their outer sides (not shown in the figure).

The microwave baking tray is provided with ventilation holes 19, which are located on the top surface of the baking tray sheath or the side wall 20 of the second sheath of the baking tray sheath, or at the docking edge 21 of the baking tray sheath.

A positioning structure can further be arranged on the baking tray sheath to facilitate quick alignment when the upper and lower baking trays are aligned position and snapped with each other.

### Embodiment 2

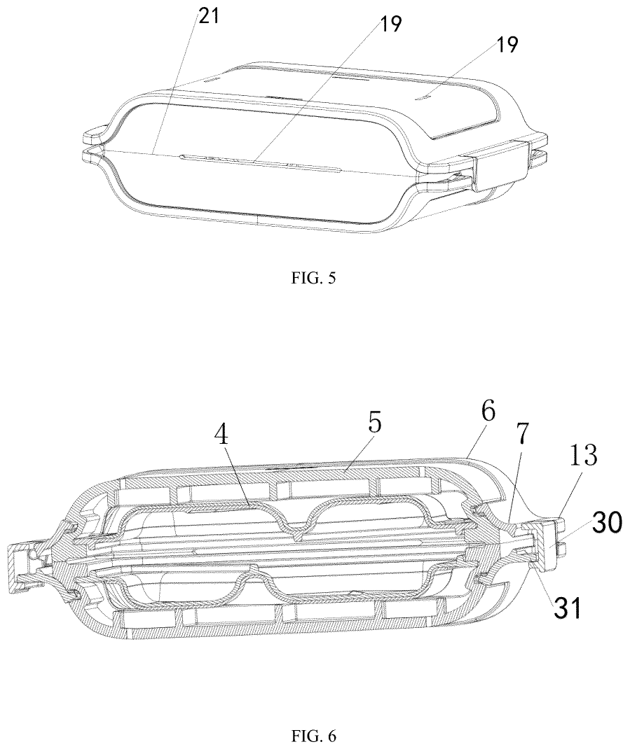

Referring to FIGS. 5-6, in this embodiment, the bottom edge of the lower horizontal bar is at a distance from the notch of the baking tray sheath, so that after the support is snapped, the two horizontally arranged locking plates 13 are parallel and spaced apart. The remaining structure is the same as in the embodiment 1.

What is claimed is:

1. A microwave baking tray with rigid supports, comprising a pair of supports and a microwave baking tray, wherein the supports are installed on an outer side of an upper unit and an outer side of a lower unit of the microwave baking tray, a lock catch is arranged on the supports, the lock catch is used to align position and snap with the upper unit and the lower unit, the upper unit and the lower unit of the microwave baking tray both comprises metal baking trays and baking tray sheaths, the supports comprise an upper horizontal bar and a lower horizontal bar, the upper horizontal bar is snapped with a top surface of the baking tray sheath, the lower horizontal bar is snapped with a side wall of a first sheath near a notch of the baking tray sheath, the upper horizontal bar and the lower horizontal bar are connected by a connecting bar to form a frame structure, and the rigidity of the supports is greater than that of the baking tray sheath.

2. The microwave baking tray according to claim 1, wherein the upper horizontal bar and the lower horizontal bar are not on the same plane, a plurality of buckles are distributed along frames of the supports, and the baking tray sheath is provided with installation grooves along a distribution of buckles.

3. The microwave baking tray according to claim 2, wherein the installation grooves are continuous and closed on a surface of the baking tray sheath, and the installation grooves are provided with buckle holes corresponding to each of the buckles.

4. The microwave baking tray according to claim 3, wherein the lower horizontal bar extends outward with a locking plate in a direction away from a center of the baking tray sheath, and the locking plate is provided with an U-shaped groove.

5. The microwave baking tray according to claim 4, wherein the microwave baking tray is provided with ventilation holes, the ventilation holes are located on the top surface of the baking tray sheath or a side wall of a second sheath of the baking tray sheath, or at a docking edge of the baking tray sheath.

6. The microwave baking tray according to claim 4, wherein each of the supports consists of an upper support and a lower support, the upper support and the lower support are respectively provided with the U-shaped grooves, the lock catch comprises a locking cover and a latch plate, the locking cover is hinged in the U-shaped groove of the upper support, and the latch plate is integrated on a bottom bend of the U-shaped groove of the lower support.

7. The microwave baking tray according to claim 4, wherein hinge shafts are arranged on both sides of the U-shaped groove of the upper support, a hinge hole is arranged on the lock cover correspondingly, and the hinge hole is provided with an guiding bell mouth.
